(19) United States
(12) Patent Application Publication
(10) Pub. No.: US 2007/0130083 A1
(43) Pub. Date: Jun. 7, 2007

(54) Method and apparatus for making a charitable donation

(75) Inventor: Alana K. Berlin, Chamblee, GA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: 360 Degree Giving, LLC, Chamblee, GA (US)

(21) Appl. No.: 11/297,053

(22) Filed: Dec. 7, 2005

(51) Int. Cl. G06Q 99/00

(52) U.S. Cl. 705/65

(57) ABSTRACT

An apparatus and method of making a donation to a donee is disclosed. The apparatus includes a card having machine readable information including but not limited to the amount of the donation and the donee. The retailer enters information about the donation into a retail point of sale device and the donor pays for the amount of the donation. The donee receives the amount of the donation and pays service fees.

### FIELD OF THE INVENTION

This invention relates generally to charity donations and more particularly to a method and apparatus for merchandising charitable donations as gifts, collecting donations and transferring funds to nonprofit organizations, schools, colleges or charitable organizations.

### BACKGROUND OF THE INVENTION

Donations made by one person on behalf or in honor of another person are a common practice in our society. Often, such donations are made when expressing condolences upon a death. For example, gifts in memory of the deceased are often made, particularly when the family has requested gifts in lieu of flowers. The family is typically notified of the gifts by personal note from the donor or through the donee, if the donee is a charity or other organization. In the latter case the donor provides the family's name and address to the charity at the time the gift is made.

Additionally, donations are many times made on behalf of another as a gift or token of recognition, to honor or to celebrate a holiday or an event. Donations on another's behalf are known as: Tribute gifts, Memorial gifts, In Honor gifts, Commemorative gifts and Legacy gifts.

This practice is currently accomplished in various ways: by phone, by mail or online.

Once the donation is made to the charity, the gift recipient (or family of the honoree) is sent an acknowledgement or thank you letter from the charity.

The current donation options are not optimal for a variety of reasons. One reason is that currently donations require the giver to expend some effort or do work, for example, look up an address—physical or web, a phone number, write a check and mail it, etc. This effort provides a disincentive to giving. Another reason that the current methods are inadequate is that there is not an immediate physical expression of the gift or sentiment to be presented to the recipient. Also, in many cases there is a significant time delay in the gift acknowledgement by the charity. Additionally charities incur opportunity costs because they are not currently a consideration in the decision set when consumers are shopping for gifts and they also forego an opportunity for impulse purchases.

### SUMMARY OF THE INVENTION

The present inventions overcome the disadvantage of prior art methods by providing an easy way for a donor to make a donation to a donee at a retail establishment. A donation card having machine readable indicia containing static information relating to the nature of the donation is provided at a retail establishment. The card includes a severable fold that allows the card to be separated into a first and second portion.

The second portion includes creases enabling the second portion to be folded into a self-contained post card.

The invention also contemplates a method of making a donation that includes the steps of disposing a donation card having information including an amount and a donee at a retail establishment, entering the item to a retail point of sale device; charging the donor for the amount of the donation card; and paying the donee the amount of the donation card.

In another embodiment, the donation card may have a unique identifier but no donee identified on the card. The donor would access a web site to identify one of a number of donees and input the unique identifier on the site so that the donation amount can be correlated with the donee.

### BRIEF DESCRIPTION OF THE DRAWINGS

There are shown in the drawings embodiments, which are presently preferred, it being understood, however, that the invention is not limited to the precise arrangements and instrumentalities shown, wherein:

FIG. 1 is a front view of the donation card assembly according to this disclosure.

FIG. 2 is a rear view of the donation card according to this disclosure.

FIG. 3 is a front view of the donation card illustrating the detachment of the holding portion

FIG. 4 illustrates how the card portion folds into a self-contained post card

FIG. 5 illustrates the folded post card

FIG. 6 is a flow diagram illustrating the method of the disclosure.

### DETAILED DESCRIPTION OF THE PREFERRED EMBODIMENTS

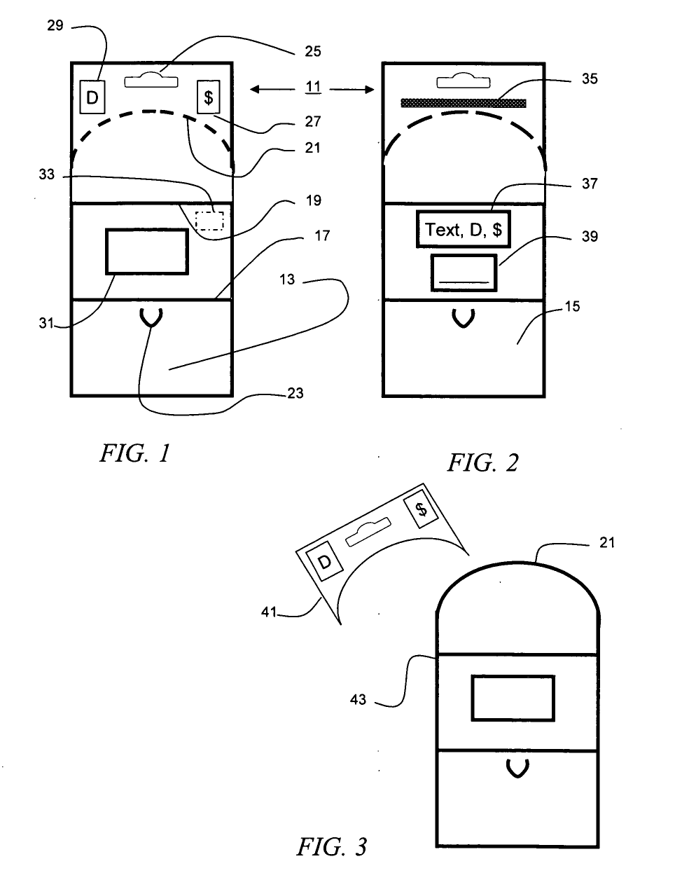

A donation card 11 according to the invention is shown in FIGS. 1 and 2. The donation card 11 comprises at least a front portion 13 and a back portion 15. The donation card 11 may include creases 17 and 19 and a severable crease 21 (e.g. perforated portion). The donation card 11 may also include a tab 23 and a slot 25. Slot 25 is designed to fit typical display hooks in display systems commonly used by retailers. The donation card 11 may include denomination indicia 27 indicating the dollar (or other currency) amount that will be charged to the donor (the person making the gift) and will be paid to the donee (recipient of the donation). Donation card 11 also may include the indicia 29 that identifies the donee. Donation card 11 may also include a blank (or alternately lined) section 31 where the donor may write the name and address of the person in whose honor the gift is being made. The donation card may also include a stamp section 33 where a stamp may be attached, or for the printing of a pre paid postage.

In an alternate embodiment instead of including donee indicia 29, the card may include a unique identifier and a web site address for a web site listing potential donees. The purchaser or gift recipient may then access the web site to choose one of a plurality of donees and input the unique identifier to correlate the rest of the information on the card (e.g. donation amount) with the selected donee.

Illustrated in FIG. 2 is the back portion 15 of the donation card 11. Included in the back portion 15 is a machine-readable means for encoding information 35. One example of a machine-readable means for encoding information is a magnetic stripe such as the magnetic strip found in the back of a credit card. Alternately, the machine-readable means for encoding information may comprise a UPC code. When item is entered into a retail point of sale device at the checkout, the point of sale device reads and sends the indicia encoded information to the store's central point of sale computer. The central computer sends back the information needed to complete the purchase of the donation card. Yet another means for encoding information 35 may be an RFID device. As can be seen from the description above, many technologies can be utilized to identify uniquely a type of donation card in a way that can be used in the method described below. Alternately, the consumer may specify an amount as with “price required” barcodes or magnetic strips when the retailer has to input the item for sale.

Also illustrated in FIG. 2 is text block 37, which may includes information about the donee and the amount of the gift that was made. An example of content in text block 37 may be “A gift in the amount of $50.00 was made to [donee] in honor of . . . ” The name of the person in whose name the gift would be made would be inserted in name block 39.

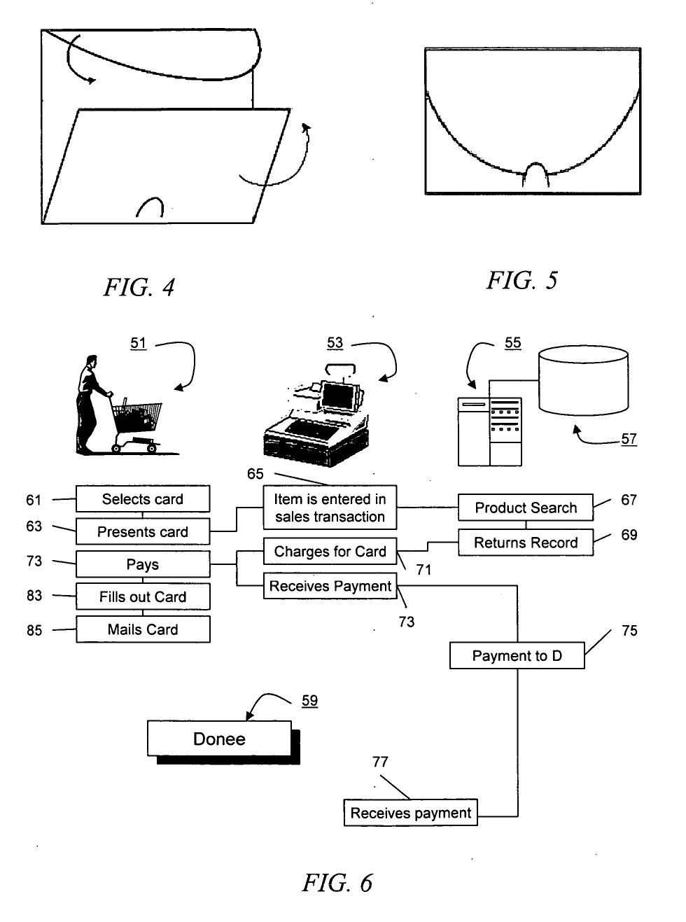

Illustrated in FIG. 3 is the donation card 11 that has been separated at severable crease 21 yielding a receipt portion 41 and an envelope portion 43? The receipt portion 41 may be retained for the records of the donor. The sales receipt will be used for tax purposes. Envelope portion 43 may be filled out with the appropriate information by the donor, folded as illustrated in FIGS. 4 and 5, and mailed to the person or family of the person in whose name the gift has been made.

FIG. 6 Illustrates the processes involved in the making of a donation in accordance with the present invention. There are four actors in the process, the donor 51, the retailer's point of sale device 53, the retailer's central point of sale computer 55 (with associated data storage unit 57) and the donee 59. The donor 51 selects a card in step 61 and presents the card in step 63 at the point of sale 53 of the retailer. The retailer enters the item to point of sale device in step 65 and the retailers central point of sale computer 55 searches its database for the product identification in step 67. Associated with the UPC or other product identifier is information about the price and the donee. The central point of sale computer 55 returns the item record in step 69 to the point of sale device 53 and the information needed to complete the transaction is added in step 71. The donor pays the amount of all transactions in step 73. When the point of sale device 53 indicates that payment has been received in step 73, the central point of sale computer 55 instructs in step 75 payment of the amount of the donation less service fees to be made to the donee 59. In this manner, the donee receives the donation less the service fees and can make a separate payment for additional services associated with this fundraising effort in step 77.

What is claimed:

1. An apparatus for making a donation to a donee, comprising:
a card, said card having a front and a back and a severable crease whereby the card can be separated into a first portion and a second portion;
indicia containing static information regarding to the nature of the donation on the card; and
means for encoding information about donation and said donee on said card.

2. The apparatus of claim 1 wherein said card also includes two additional foldable creases whereby the card can be folded into a self contained post card.

3. The apparatus of claim 1 wherein said first portion includes indicia identifying the donee.

4. The apparatus of claim 1 wherein said first portion includes a unique identifier and a web site address for selecting donees.

5. The apparatus of claim 1 wherein the indicia of said first amount is disposed on said first portion.

6. An apparatus for making a donation to a donee on behalf of a third party, comprising:
a card, said card having a front and a back and a severable crease whereby the card can be separated into a first portion and a second portion;
indicia of said donation on the card; and
means for encoding information about said donation and said donee on said card;
said second portion of the card having a blank section on which the donor can write the name and address of said third party.

7. The apparatus of claim 6 wherein said second portion includes two creases whereby the second portion can be folded into a self contained post card.

8. The apparatus of claim 7 further comprising a tab formed on said second portion; said tab being disposed to engage an edge of the second portion and secure that edge in a folded position.

9. A method of making a donation to a donee on behalf of a third party comprising:
disposing a donation card having information including a donation amount at a retail establishment;
selecting a donee;
entering the item to a point of sale device of the retailer;
charging the donor the donation amount; and
paying the donee the donation amount less service fees.

10. The method of claim 9 wherein said donation card has indicia identifying the donee and said step of selecting the donee comprises the step of selecting a card with the indicia of the desired donee.

11. The method of claim 9 wherein said donation card includes a unique identifier and a web site address for a web site having a list of potential donees, and where said step of selecting a donee comprises:
accessing the web site;
selecting a donee from a list of potential donees;
communicating the unique identifier to the web site whereby information on the donation card can be correlated to the selected donee.
